(19) United States
(12) Patent Application Publication
(10) Pub. No.: US 2025/0034059 A1
(43) Pub. Date: Jan. 30, 2025

(54) BIOBASED FERTILIZER COATINGS WITH NANOPARTICLES

(71) Applicants: EUROCHEM ANTWERPEN, Antwerpen (BE); UNIVERSITEIT ANTWERPEN, Antwerpen (BE)

(72) Inventors: Serge TAVERNIER, Antwerpen (BE); Jef WENS, Antwerpen (BE); Yorick CLAUWERS, Antwerpen (BE); Steve HELFENSTEYN, Antwerpen (BE); Fabian JANSSENS, Antwerpen (BE)

(73) Assignees: EUROCHEM ANTWERPEN, Antwerpen (BE); UNIVERSITEIT ANTWERPEN, Antwerpen (BE)

(21) Appl. No.: 18/706,868

(22) PCT Filed: Nov. 27, 2022
(86) PCT No.: PCT/EP2022/083383

§ 371 Date: May 2, 2024

(30) Foreign Application Priority Data
Dec. 7, 2021 (BE) 2021/5951

(51) Int. Cl. C05G 3/30; C05G 1/00; C05G 5/30

(52) U.S. Cl. CPC C05G 3/30; C05G 1/00; C05G 5/38

(57) ABSTRACT

Anti-caking fertilizer particles (100) comprising an inorganic fertilizer core (102) and a bio-based wax coating (106) are disclosed. The bio-based wax coating (106) comprises nanoparticles (104). The nanoparticles (104) do not extend beyond the surface of the bio-based wax coating (106).

### FIELD OF THE INVENTION

The invention concerns the field of biobased fertilizer coatings to provide anti-caking properties by preventing water absorption. In this respect, biodegradability of the coating material is essential to meet new regulatory requirements for the reduction and prevention of microplastics.

### Inorganic Particles as Roughening Components

EP3911621 published as WO2020150579 pending to Mosaic discloses muriate of potash (MOP) solid fertilizer granules (202) covered with finely ground phosphate rock as roughening components (204) shown in comparative FIG. 2. Candelilla wax is applied as a low energy material (206) to obtain the coated particles (200). Silicates or sand are only mentioned amongst a list of possible roughening components (202). The roughening components (202) preferably are of a large size in the range of 10 μm to 150 μm in order to produce the required surface roughness. The hydrophobic coating (206) preferably is applied in large amounts from 0.5 wt % to 2 wt %. This increases the production costs of the granules. The roughening components (202) are protruding through the hydrophobic coating (206). That means that the roughening components (202) are covered by the coating. However, the roughening components (202) are not entirely embedded in the coating. Consequently, Mosaic proposes a coating with a rough surface as shown in comparative FIG. 2. This roughness produces instability or cracking through mechanical impact over time. Also the surface roughness reduces flowability and thus transportability of the fertilizer granules.

### Inorganic Particles for Water Ingression Control

Inert inorganic particles have been included in coatings as fillers to seal the pores of the fertilizer granules, slowing water ingress and therefore nutrient release from the product. For example, NZ596113A to South Star Fertilizers discloses coated inorganic fertilizer particles. Multiple layers of coatings each with powdered trace elements are proposed in order to obtain the water ingression control. However, multiple layers increase the manufacturing cost and complicates the manufacturing process.

### Inorganic Particles for Preventing Flotation

The use of silica has also been described to prevent flotation. For example, JP03232788A inactive to Nissan Chemical discloses a method to prevent flotation of fertilizer granules in paddy fields. The surface is coated with a low-molecular hydrophobic component and a fine powder of hydrated silicon oxide is applied to the surface of the coating layer. However, the added particles are hydrophilic to produce the anti-floatation effect through the interaction with the water in the rice paddies.

### Technical Problem

Therefore, there remains a need for cost-effective, biodegradable, and flowable fertilizer particles that show low caking through decreased water absorption and that are mechanically stable during production, transportation and storage.

### SHORT DESCRIPTION OF THE INVENTION

The inventors have surprisingly found that caking through water absorption may be successfully prevented in a sustainable manner by applying a thin coating on inorganic fertilizer cores. The coating is a mixture of a biobased wax and nanoparticles. The size of the nanoparticles is smaller than the thickness of the coating to produce a smooth surface.

Accordingly, a first aspect of the present invention are anti-caking fertilizer particles (100), comprising an inorganic fertilizer core (102) and a bio-based wax coating (106),
wherein the bio-based wax coating (106) comprises nanoparticles (104); and
wherein the nanoparticles (104) do not extend beyond the surface of the bio-based wax coating (106).

In another aspect, the nanoparticles (104) are silica nanoparticles.

In another aspect, the size of the nanoparticles (104) is smaller than the thickness of the bio-based wax coating (106).

In another aspect, the nanoparticles (104) have a primary particle size smaller than 1/100 as compared to the size of the inorganic fertilizer core (102), preferably smaller than 1/500, and even more preferably smaller than 1/1000 the size of the inorganic fertilizer core (102) and even more preferably smaller than 1/2000 the size of the inorganic fertilizer core.

In another aspect, the silica particles (104) are present in the bio-based wax coating (106) in an amount from 5 m % or more, preferably 7, 5 m % or more as compared to the total mass of the bio-based wax coating (106).

In another aspect, the silica particles (104) are present in the bio-based wax coating (106) in an amount from 15 m % or less, preferably, from 12,5 m % or less as compared to the total mass of the bio-based wax coating (106).

In another aspect, the bio-based wax coating (106) is applied by melt-spraying.

In another aspect, the bio-based wax is applied to the inorganic fertilizer core (102) in an amount from 0,1 kg/t to 10 kg/t, preferably from 0,5 kg/t to 5 kg/t, even more preferably from 1 kg/t to 3 kg/t (kg per ton of fertilizer cores).

In another aspect, the thickness of the biobased wax coating is from 1 microns to 5 microns, preferably from 1.25 microns to 3.75 microns or from 1 to 2.5 microns.

In another aspect, the nanoparticles (104) are immersed in the bio-based wax coating (106).

In another aspect, the melting point of the bio-based wax is
from 40° C. or more, preferably from 50° C. or more, even more preferably from 60° C. or more; or
from 100° C. or less, preferably from 90° C. or less, even more preferably 80° C. or less.

In another aspect, a lubricant is added to the anti-caking fertilizer particles (100) to stabilize the anti-caking efficiency.

In another aspect, the lubricant is magnesium stearate.

In another aspect, the anti-caking fertilizer particles (100) further comprise a primer layer (110) arranged between the inorganic fertilizer core (102) and the bio-based wax coating (106).

In another aspect, the bio-based wax is an oilseed-rape-based wax.

In another aspect, the diameter of the inorganic fertilizer core (102) is from 0.1 mm to 10 mm, preferably from 1 mm to 5 mm and even more preferably from 2 mm to 4 mm.

In another aspect, the inorganic fertilizer core (102) comprises nitrogen, phosphorus or potassium or combinations thereof and preferably is a NPK fertilizer.

Another aspect of the invention is a method of manufacturing the anti-caking fertilizer particles (100), comprising:
melt-spraying the bio-based wax with the nanoparticles (104) on the inorganic fertilizer core (102) to obtain the anti-caking fertilizer particles (100)
optionally adding a lubricant during or after the melt-spraying;
optionally applying a primer layer to the inorganic fertilizer core (102) prior to the melt-spraying of the bio-based wax; In another aspect, the viscosity of the a bio-based wax coating (106) is between 1 and 200 Pa·s, more preferably between 2 and 100 Pas, even more preferably between 2 and 25, Pa·s, and even more preferably between 2 and 15 Pa·s at 10° C. above the melting point of the bio-based wax coating (106).

Another aspect of the invention are the anti-caking fertilizer particles (100) obtained by the method of the invention.

Another aspect is the use of a bio-based wax coating (106) for an anti-caking fertilizer coating,
wherein the bio-based wax coating (106) comprises nanoparticles (104); and
wherein the size of the nanoparticles (104) is smaller than the thickness of the bio-based wax coating (106).

Another aspect is a method for reducing caking of fertilizer particles (100),
wherein a bio-based wax coating (106) is applied to an inorganic fertilizer core (102);
wherein the bio-based wax coating (106) comprises nanoparticles (104); and
wherein the nanoparticles (104) do not extend beyond the surface of the bio-based wax coating (106).

Another aspect is method for increasing the viscosity in a bio-based wax coating (106) for anti-caking fertilizer particles (100),
wherein a bio-based wax coating (106) is applied to an inorganic fertilizer core (102) preferably by melt-spraying;
wherein the bio-based wax coating (106) comprises nanoparticles (104); and
wherein the nanoparticles (104) do not extend beyond the surface of the bio-based wax coating (106).

### SHORT DESCRIPTION OF THE DRAWINGS

FIG. 1 illustrates a partial schematic cross section view of the anti-caking fertilizer particles (100) of the invention.

FIG. 2 shows a schematic cross-section view the coated potash particles (200) of the state of the art as exemplified in WO 2020/150579 (Mosaic).

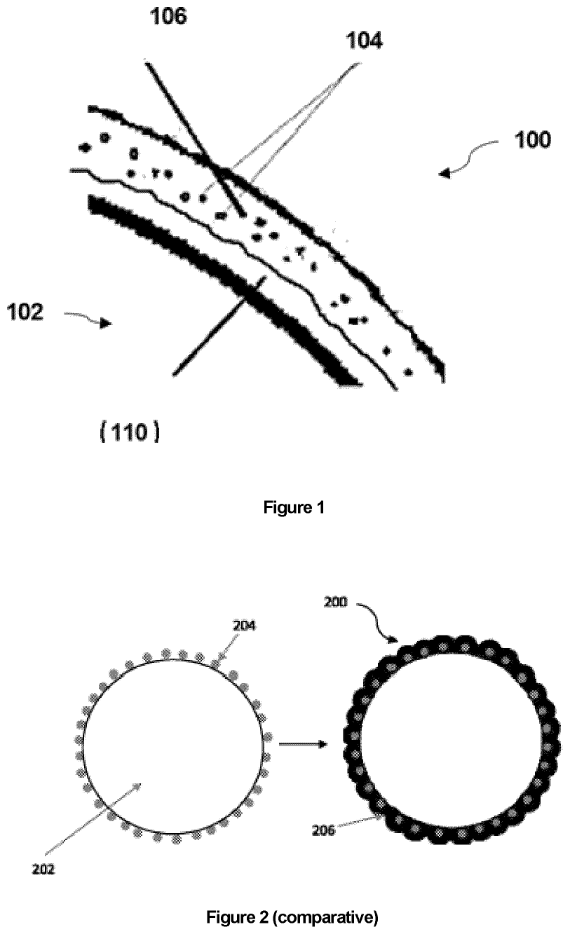

### DETAILED DESCRIPTION OF THE INVENTION

Preferred embodiments are described hereinafter without, however, limiting the scope of the present invention:

### Bio-Based Wax

In one embodiment, the bio-based wax is a plant-based wax, in particular an oilseed-rape-based wax. The bio-based wax preferably is biodegradable and renewable. The bio-based wax preferably is a fully saturated waxes.

Suitable bio-based waxes are for example commercially available under the brand Agri-pure™ Industrial Vegetable Waxes from Cargill.

Preferably, the melting point of the bio-based wax is
from 40° C. or more, preferably from 50° C. or more, even more preferably from 60° C. or more; or
from 100° C. or less, preferably from 90° C. or less, even more preferably 80° C. or less.

The bio-based is preferably applied to the inorganic fertilizer core (102) in an amount from 0,1 kg/t to 10 kg/t, preferably from 0,4 kg/t to 5 kg/t, even more preferably from 1 kg/t to 3 kg/t as compared to the weight of the inorganic fertilizer core (102).

### Nanoparticles

Preferably the nanoparticles (104) have a primary particle size of smaller than 1/100 as compared to the size of the inorganic fertilizer core (102), preferably smaller than 1/500, and even more preferably smaller than 1/1000 of the size of the inorganic fertilizer core (102). The size of the nanoparticles (104) is smaller than the thickness of the bio-based wax coating (106).

Preferably, the diameter of the inorganic fertilizer core (102) is from 0.1 mm to 10 mm, preferably from 1 mm to 5 mm and even more preferably from 2 mm to 4 mm.

Preferably, the nanoparticles (104) are present in the bio-based wax coating (106) in an amount from 5 m % or more, preferably, 7, 5 m % or more as compared to the total mass of the bio-based wax coating (106).

Preferably, the nanoparticles (104) are present in the bio-based wax coating (106) in an amount from 15 m % or less, preferably, from 12,5 m % or less.

The nanoparticles (104) preferably are silica nanoparticles, even more preferably amorphous silica nanoparticles (CAS-No. 68611-44-9). The nanoparticles (104) preferably have a specific surface area weight (BET) from 90 to 130 m²/g. The nanoparticles (104) preferably have a pH value in a 4% dispersion of 3 to 6. The nanoparticles (104) preferably have a SiO2 content of 95 m % or more, even more preferably of 98 m % or more, even more preferably of 99 m % or more. The nanoparticles (104) preferably are fumed silica after-treated with dimethyldiclorosilane (DDS). An example of suitable nanoparticles (104) is the hydrophobic fumed silica commercially available under the brand Aerosil® R972 from Evonik.

Preferably, the primary size of the nanoparticles is determined at the most equivalent thickness of the bio-based wax coating. The said primary size of the nanoparticles is obtained from the specific surface area by the following formula:

$${D}_{p} = 6 / ρ . SSA$$

Where Dₚ is the primary particle diameter, SSA is the specific surface area of the nanoparticles determined by BET, ρ is the specific gravity of the nanoparticle material.

The BET preferably is calculated using the standard DIN ISO 9277: Determination of the specific surface area of solids by gas adsorption using the BET method by the German Institute of Normalization (DIN); 1995. p. 1-19.

The nanoparticles (104) have preferably a primary particle size of smaller than 1/100, preferably smaller than 1/500, and even more preferably smaller than 1/1000 the size of the inorganic fertilizer core (102).

In another aspect, the nanoparticles (104) have a primary particle size of smaller than 5 microns, preferably of smaller than 1 microns and even more preferably of smaller than 0,5 microns, even more preferably of smaller than 0,1 microns, even more preferably of smaller than 0,01 microns.

In another aspect, the nanoparticles (104) have a primary particle size of 5 nm to 25 nm, preferably from 10 nm to 20 nm.

In another aspect, the nanoparticles (104) are present in the bio-based wax coating (106) in an amount from 5 m % or more, preferably, 7, 5 m % or more as compared to the total mass of the bio-based wax coating (106).

In another aspect, the nanoparticles (104) are present in the bio-based wax coating (106) in an amount from 15 m % or less, preferably, from 12,5 m % or less.

### Inorganic Fertilizer Core

In one embodiment, the inorganic fertilizer core (102) comprises nitrogen, phosphorus or potassium or combinations thereof and preferably is an NPK fertilizer.

### Nanoparticles not Extending Beyond the Surface of the Bio-Based Wax Coating

In another embodiment, the nanoparticles of the invention do not extend beyond the surface of the bio-based wax coating. This means that the nanoparticles are essentially immersed or embedded in the bio-based wax coating such that the surface of the anti-caking particles is essentially smooth.

In another embodiment, a small fraction of the nanoparticles may still protrude through the surface. An example of protruding nanoparticles as roughening agents is shown in comparative FIG. 2. However, the protruding nanoparticles of the invention are less than 30 w % of the total dry weight of the nanoparticles (104) and even more preferably less than 10 w % of the total dry weight of the nanoparticles (104). In another embodiment less 5 w %, or even less than 1 w % of the nanoparticles are protruding through the surface as shown for the protruding roughening agents in comparative FIG. 2.

Protruding means that the shape of the nanoparticles is discernible on the surface of the anti-caking fertilizer particles (100) as shown for the protruding roughening agents in comparative FIG. 2.

The number of protruding nanoparticles and their corresponding weight can be estimated for example through electron-microscopy. Typically, at least 10 anti-caking particles are assessed to arrive at an average protrusion value.

Embedded means that the nanoparticle is fully covered by the bio-based wax coating to allow for a smooth surface of the bio-based wax coating. Consequently, embedded nanoparticles are not discernible as surface protrusions such as shown for the protruding roughening agents in comparative FIG. 2.

The surface smoothness of the present invention is important for the stability of the anti-caking fertilizer particles (100). If the surface of the anti-caking fertilizer particles (100) is too rough, for example as shown in comparative FIG. 2, than the coating more easily breaks during processing, transport or storage.

### Primer Layer

In one embodiment, the anti-caking fertilizer particles (100) further comprise a primer layer (110) arranged between the inorganic fertilizer core (102) and the bio-based wax coating (106).

The primer layer preferably has a polar group and a long apolar chain. Examples include triglycerides, diglycerides, monoglycerides, fatty acids, fatty alcohols, fatty amides.

Preferably, the primer layer is biodegradable and bio-based.

### Lubricants

Preferred lubricants are powdered inorganic particles such as magnesium stearate which may be added to further stabilize the anti-caking fertilizer particles (100). In another aspect, a lubricant is added to the anti-caking fertilizer particles (100) to stabilize the anti-caking efficiency. The lubricant may be added in similar amounts as the nanoparticles (104). Preferably, the lubricant is added after the melt-spraying of the bio-based wax coating (106) on the fertilizer cores (102).

### Anti-Caking Fertilizer Particles

WO2020150579 pending to Mosaic discloses muriate of potash (MOP) solid fertilizer granules (202) covered with finely ground phosphate rock as roughening components (204), as shown in FIG. 2.

Contrary to the particles of the state of the art shown in FIG. 2, the particles of the present invention are anti-caking fertilizer particles (100), comprising an inorganic fertilizer core (102) and a bio-based wax coating (106),
wherein the bio-based wax coating (106) comprises nanoparticles (104); and
wherein the size of the nanoparticles (104) is smaller than the thickness of the bio-based wax coating (106).

Preferably, the bio-based wax coating (106) is applied by melt-spraying, but may also be applied by other methods. The nanoparticles (104) increase the viscosity of the bio-based wax and thus facilitate its application on the fertilizer core (102).

In another aspect, the bio-based wax coating (106) is applied to the inorganic fertilizer core (102) in an amount from 0,1 kg/t to 10 kg/t, preferably from 0,5 kg/t to 5 kg/t, even more preferably from 1 kg/t to 3 kg/t.

In another aspect, the nanoparticles (104) are immersed in the bio-based wax coating (106) or are attached to the surface of the bio-based wax coating (106).

Application of the Bio-Based Wax Coating with Nanoparticles

Several application methods are possible to coat the fertilizer cores with the bio-based wax coating.

### Melt-Spraying

A preferred application method is melt-spraying. However, the filler content in the wax and the corresponding viscosity of the filled wax cannot be too high to allow for an even encapsulation and a smooth surface, as shown in the viscosity data of example 2.

### Further Application Methods

Another preferred application method is to add the coating mixture, comprising the biobased wax and the nanoparticles, as a solid powdery material to the fertilizer cores (102). In a first step the biobased wax is molten and the nanoparticles are admixed to said molten biobased wax. After the mixing step, the mixture is allowed to cold and solidify. The said solidified product is crushed to a fine powder, preferably smaller than 1 mm, more preferably smaller than 0,5 mm, even more preferably smaller than 0,2 mm. The fine powder coating particles are admixed to the fertilizer cores (102). The fertilizer cores (102) have a temperature at least 10° C. above the melting point of the biobased wax. The mixing proceeds over a sufficient time frame to allow the coating material to melt, to wet the surface of the fertilizer beads and to spread evenly over said surface. In a final step the coated fertilizer beads are allowed to cool to ambient conditions.

### Viscosity Increase Through Nanoparticles

The viscosity of the blend of molten bio-based wax and nanoparticles is between 1 and 200 Pa·s, more preferably between 2 and 100 Pa·s, even more preferably between 2 and 15 Pa·s at 10° C. above the melting point of the blend.

Suitable methods for measuring the viscosity are known to the skilled person. The viscosity is preferably measured with a rheometer HAAKE Rheowin 4.87.0010: Rheostress 1 (RS1) commercially available from Thermo Fisher. Preferably, the configuration of the rheometer is as follows:
Parallel plate configuration 60 mm and gap 0,5 mm;
Measurement frequency of 1 Hz; and
Temperature range 100° C. towards 40° C. decreasing over 4800 s.

Accordingly, another aspect of the invention is a method for increasing the viscosity in a bio-based wax coating (106) for anti-caking fertilizer particles (100),
wherein a bio-based wax coating (106) is applied to an inorganic fertilizer core (102) preferably by melt-spraying;
wherein the inorganic fertilizer core (102) is a nitrogen-containing fertilizer; and
wherein the bio-based wax coating (106) comprises nanoparticles (104).

### Anti-Caking Effect Through the Bio-Based Wax Coating

The bio-based wax coating (106) of the present invention reduces the caking of nitrogen-containing fertilizer particles through water absorption.

Accordingly, another aspect of the invention is a method for reducing caking of fertilizer particles (100),
wherein a bio-based wax coating (106) is applied to an inorganic fertilizer core (102);
wherein the inorganic fertilizer core (102) is a nitrogen-containing fertilizer; and
wherein the bio-based wax coating (106) comprises nanoparticles (104).

Also, the use of the bio-based wax coating (106) for reducing the caking of nitrogen-containing fertilizer particles through reduced water absorption is an object of the invention.

### Examples

The invention is further illustrated by following examples which are not meant to limit the scope of the invention.

### 1. Anticaking

NPK Fertilizer granules (15-15-15) with a particle size between 2,5 mm to 4 mm were coated with different coatings. The composition of the fertilizer core (weight/weight %) is expressed as total nitrogen as P2O5 and as K2O respectively. Typical water content of the fertilizer core is 0,8% to 1,0% w/w. The compositions are shown in Table 1 below.

The intimate nanoparticle wax coating mixture was made by melting the wax to 90° C. and adding the nanoparticles to it under vigorous mixing. Then the temperature is slowly decreased to 5° C. above the melting point of the wax whilst stirring. Then the mixture is allowed to cool to room temperature. The coating mixture is then pulverized using a laboratory mill down and sieved to obtain a powdery substance with a size smaller then 0,5 mm.

The fertilizer cores were heated with hot air at 250° C. to 300° C. up to 90° C. in a rotating pan. Pulverized coating with an average particle diameter of smaller than 500 microns is evenly distributed. The coating particles melt to enrobe the fertilizer granule in the rotating pan. The coated particles are allowed to cool down to room temperature whilst stirring. An equilibration period of at least 3 days in applied before the anti-caking is measured.

The lubricant is added at room temperature by adding the lubricating agent to the agitated granules in the rotating pan for 30 minutes.

Following components were used:
Bio-based wax: a fully saturated oilseed rape-based vegetable wax with a melting point of 68° C.; commercially available under the brand Agri-pure™ wax 660 (AP660) from Cargill,
Silica nanoparticles: hydrophobic amorphous silica with a surface area weight of 90-130 m2/g; primary particle size: 16 nm; commercially available under the brand Aerosil® R972 from Evonik.
Lubricant: hydrophobic Mg-stearate lubricating powder
Nitrogen-containing fertilizer core: NPK (15-15-15 Rosa), mean particle diameter: 2-4 mm

The coating composition based on the AP660 wax and R972 nanoparticles has a melting point of 60° C. The comparative example is polyethylene wax (PE-wax) coated NPK (15-15-15 Rosa). The amount of coating is expressed in kg coating per ton of fertilizer core granules. The components of the coating composition are compressed. The coating of the invention decreases caking. The caking effect may be further stabilized through the addition of a lubricant.

The ingredients of example 1 according to the present invention are selected in a way that they are non-toxic, biobased, biodegradable and renewable. The comparative example with PE-wax is not biodegradable, not biobased nor renewable. Consequently, the present invention offers a new type of fertilizer for a more sustainable future.

TABLE 1
Anti-caking performance

| | | Silica | Lubricant | Coating/ | |
|---|---|---|---|---|---|
| | | m % of the | m % of the | fertilizer | Caking |
| Example | Coating | coating | coating | kg/t | kg |
| 1.1 | 0 | 0 | 0 | 0 | 53 |
| comparative | | | | | |
| 1.2 | PE-wax | 0 | 0 | 1 | 18 |
| comparative | | | | | |
| 1.3 | PE-wax | 0 | 0 | 2 | 13 |
| comparative | | | | | |
| 1.4 | AP660 | 10 | 0 | 2 | 5 |
| 1.5 | AP660 | 12.5 | 0 | 2 | 2 |
| 1.6 | AP660 | 10 | 0 | 2 + 0.1* | 2 |
| 1.7 | AP660 | 12.5 | 0 | 2 + 0.1* | 4 |
| 1.8 | AP660 | 0 | 5 | 2 | 15 |
| comparative | | | | | |
| 1.9 | AP660 | 7.5 | 5 | 2 | 3 |
| 1.10 | AP660 | 10 | 5 | 2 | 9 |
| 1.11 | AP660 | 12.5 | 5 | 2 | 4 |
| 1.12 | AP660 | 12.5 | 0 | 1 + 1 + | 11 |
| | | | | 0.1** | |

*Coating with 2 kg/t and lubricant added after coating in amount of 0.1 kg/t
**Priming with AP660 (1 kg/t), then coating at 1 kg/t, then adding of lubricant in amount of 0.1 kg/t

The anti-caking is measured by following method:

160 gr of fertilizer beads (=cores) are conditioned for at least 3 days at ambient conditions: room temperature and RH between 40-50%. A metal cylinder (heat jacket) with internal diameter 6,0 cm and height 10,0 cm is filled with three metal rings with an external diameter 5,8 cm, internal diameter 5,5 cm and height 3,0 cm. The conditioned beads are loaded within the space confined by the two bottom metal rings and subjected to a load of 10 kg for 24 hours at 40° C. After compression the outer cylinder is removed carefully in order not to break the compacted assembly of beads and two metal rings. The assembly, i.e. the two rings containing the compacted fertilizer granules, is subjected to a lateral force by a claw to the top ring. The force to break the two metal rings and internal compacted granular bed apart (expressed in lateral kg-force) is recorded as caking (strength) value.

### 2. Viscosity

The impact of the filler on the viscosity is shown at the example of in Table 2 below.

Viscosity: Rheometer HAAKE Rheowin 4.87.0010: Rheostress 1 (RS1)

Measurements were done with a parallel plate configuration 60 mm and gap 0,5 mm. Measurement frequency of 1 Hz. Temperature range 100° C. towards 40° C. decreasing over 4800 s. The viscosity value is read at 10° C. above the melting point, i.e. in this case of AP660 based coating 60° C.

TABLE 2
Impact of filler and lubricant on coating viscosity at 70° C.:

| | | Silica | Lubricant: | Viscosity |
|---|---|---|---|---|
| | | R972 | Mg stearate | Pa · s |
| | Coating | m % | m % | at 70° C. |
| 2.1 (comparative) | AP660 | 0 | 0 | 0.04 |
| 2.2 | AP660 | 5 | 0 | 0.14 |
| 2.3 | AP660 | 10 | 0 | 1.4 |
| 2.4 | AP660 | 12.5 | 0 | 8 |
| 2.5 | AP660 | 15 | 0 | 268 |
| 2.6 | AP660 | 5 | 5 | 19 |
| 2.7 | AP660 | 10 | 5 | 33 |
| 2.8 | AP660 | 12.5 | 5 | 76 |

The following replaces all claims:

1. Anti-caking fertilizer particles comprising an inorganic fertilizer core and a bio-based wax coating,
wherein the bio-based wax coating comprises nanoparticles; and
wherein the nanoparticles do not extend beyond the bio-based wax coating.

2. The anti-caking fertilizer particles of claim 1, wherein the nanoparticles have a primary particle size of smaller than 1/100 as compared to the size of the inorganic fertilizer core, preferably smaller than 1/500, and even more preferably smaller than 1/1000 the size of the inorganic fertilizer core.

3. The anti-caking fertilizer particles of claim 1, wherein the nanoparticles are present in the bio-based was coating in an amount from 5 m % or more, preferably 7.5 m % or more as compared to the total mass of the bio-based wax coating.

4. The anti-caking fertilizer particles of claim 1, wherein the nanoparticles are present in a bio-based wax coating in an amount from 15 m % or less, preferably, from 12.5 m % or less as compared to the total mass of the bio-based wax coating.

5. The particles of claim 1, wherein the bio-based wax coating is applied by melt-spraying.

6. The anti-caking fertilizer particles of claim 1, wherein the bio-based wax is applied to the inorganic fertilizer core in an amount from 0.1 kg/t to 10 kg/t, preferably from 0.5 kg/t to 5 kg/t, even more preferably from 1 kg/t to 3 kg/t.

7. The anti-caking fertilizer particles of claim 1, wherein the nanoparticles are immersed in the bio-based wax coating.

8. The anti-caking fertilizer particles of claim 1, wherein the melting point of the bio-based wax is from 40° C. or more, preferably from 50° C. or more, even more preferably from 60° C. or more; or
from 100° C. or less, preferably from 90° C. or less, even more preferably 80° C. or less.

9. The anti-caking fertilizer particles of claim 1, wherein a lubricant is added to the anti-caking fertilizer particles to stabilize the anti-caking efficiency.

10. The anti-caking fertilizer particles of claim 1, wherein the anti-caking fertilizer particles further comprise a primer layer arranged between the inorganic buffer core and the bio-based wax coating.

11. The anti-caking fertilizer particles of claim 1, wherein the bio-based wax is an oilseed-rape-based wax.

12. The anti-caking fertilizer particles of claim 1, wherein the inorganic fertilizer core comprises nitrogen, phosphorus or potassium or combinations thereof and preferably is an NPK fertilizer.

13. A method of manufacturing the anti-caking fertilizer particles of claim 1, comprising:
applying, preferably melt-spraying, the bio-based wax on the inorganic fertilizer core to obtain the anti-caking fertilizer particles
optionally adding a lubricant during or after the melt-spraying; and
optionally adding a primer layer prior to the inorganic fertilizer core prior to the meld-spraying of the bio-based wax.

14. The method of claim 13, wherein the viscosity of a bio-based wax coating is between 1 and 200 Pa·s, more preferably between 2 and 100 Pa·s, even more preferably between 1 and 15 Pa·s at 10° C. above the melting point of the bio-based wax coating.

15. The use of a bio-based wax coating as an anti-caking fertilizer coating,
wherein the bio-based wax coating comprises nanoparticles; and

16. wherein the nanoparticles do not extend beyond the surface of the bio-based wax coating.
